(19) United States
(12) Patent Application Publication
(10) Pub. No.: US 2012/0141692 A1
(43) Pub. Date: Jun. 7, 2012

(54) METHOD FOR PRODUCING A STRUCTURE

(75) Inventor: Motoaki Sato, Tokyo (JP)

(73) Assignee: CANON KABUSHIKI KAISHA, Tokyo (JP)

(21) Appl. No.: 13/297,790

(22) Filed: Nov. 16, 2011

(30) Foreign Application Priority Data
Dec. 7, 2010 (JP) 2010-272469

(51) Int. Cl. B05D 3/06

(52) U.S. Cl. 427/561

(57) ABSTRACT

A method for producing a structure including: colliding a photocurable adhesive composition with a light source, at least a portion of which is covered with a transparent member, thereby forming a film of the photocurable adhesive composition on the surface of the transparent member; irradiating the film of the photocurable adhesive composition with light on the surface of the transparent member; and dropping the photocurable adhesive composition irradiated with light on the structure in the region to be coated, thereby applying the photocurable adhesive composition to the region to be coated, thereby preventing an occurrence of uncured areas caused by irregular irradiation with light, and an occurrence of coloration and carbonization caused by excessive irradiation.

### BACKGROUND OF THE INVENTION

1. Field of the Invention

The present invention relates to a method for producing a structure, including placing a photocurable adhesive composition in a region to be coated on an precoated structure while uniformly irradiating the composition with light.

2. Description of the Related Art

In general, curing of an adhesive composition after application is achieved by a method of, applying an adhesive composition to an object to be coated and then irradiating the object with ultraviolet light, or a method of applying an adhesive composition under irradiation with ultraviolet light. Since takt reduction must be performed for reducing the production cost in the former method, the latter method is commonly used. For example, Japanese Patent Application Laid-Open No. 2001-266420 discloses a method of dropping a cationic UV curable liquid composition onto an object to be coated. The cationic UV curable liquid composition is irradiated with ultraviolet light while it is falling towards the object, and then applied thereto.

In the above-described method, a cationic UV curable liquid composition is cured under irradiation with ultraviolet light during the falling, while being applied to a substrate. However, a long distance between the substrate and coating device is necessary for sufficient irradiation of the composition with ultraviolet light, which leads to a poor position accuracy in the application of the composition.

Taking the wiring section of a package of an electrical substrate for instance, when the above-described composition is irradiated with ultraviolet light while being applied to the electrode section, reaction of active species in the inner part will not be caused when the light is irradiated at an amount with which the adhesive can flow up to an under side of the wiring section, so that the deep portion will not be cured. In other words, while a sufficient amount of light is applied to the surface, it cannot cause active species in the inner part due to the attenuation of the light beam. On the other hand, when a sufficient amount of ultraviolet light is applied to entirely cure the composition, the surface rapidly hardens to form a film, and a viscosity in the inner portion becomes enlarged, so that the adhesive cannot be embedded under the electrical wiring. In addition, excessive irradiation may cause coloration and carbonization. As such, it is conventionally difficult to uniformly cure a photocurable adhesive composition by irradiation with light during heavy application.

### SUMMARY OF THE INVENTION

A method for producing a structure which can prevent the occurrence of uncured areas caused by irregular irradiation with light, and the occurrence of coloration and carbonization caused by excessive irradiation, will be provided herein.

A method for producing a structure according to the present invention includes: colliding a photocurable adhesive composition with a light source, at least a portion of which is covered with a transparent member, thereby forming a film of the photocurable adhesive composition on the surface of the transparent member; irradiating the film of the photocurable adhesive composition with light on the surface of the transparent member; and dropping the photocurable adhesive composition irradiated with light on the structure in the region to be coated, thereby applying the photocurable adhesive composition to the region to be coated.

Further features of the present invention will become apparent from the following description of exemplary embodiments with reference to the attached drawings.

### BRIEF DESCRIPTION OF THE DRAWINGS

FIG. 1 a schematic view of an example of an inkjet recording head produced by the method according to the present invention.

FIG. 2 is a schematic plan view of the section II in FIG. 1.

FIG. 3 is a cross sectional view along the line III-III in FIG. 2 showing an example of the method for producing an inkjet recording head according to the present invention.

FIGS. 4A, 4B, and 4C are schematic views showing examples of the shape of the light source mask according to the present invention.

FIGS. 5A, 5B, and 5C are schematic views showing the manner of broadening of the photocurable adhesive composition upon collision with light.

FIG. 6 is a schematic view showing the production flow of the method according to the present invention.

### DESCRIPTION OF THE EMBODIMENTS

Preferred embodiments of the present invention will now be described in detail in accordance with the accompanying drawings.

(Photocurable adhesive composition) A photocurable adhesive composition used in the method according to the present invention is not particularly limited as long as it is an adhesive composition cured by light emitted from a light source, and it may be, for example, an acrylic resin composition using radical polymerization, or an epoxy resin composition using ionic polymerization. Among them, the photocurable adhesive composition is preferably an adhesive composition cured by the reaction mechanism of ionic polymerization. The use of the composition allows quick adhesion, and, for example, in the production of an inkjet recording head, it reduces thermal expansion of the ink supply member and silicon substrate caused by transfer of heat from the composition.

The adhesive compositions using ionic polymerization reaction are broadly categorized into those using cationic polymerization and anionic polymerization, based on the type of the ionic reaction. Examples of the adhesive composition using anionic polymerization include cyanoacrylate instantaneous adhesives which start to react upon exposure to, for example, a trace amount of water or amine attached to the surface of the adherend. Examples of the known adhesive composition using cationic polymerization reaction include the adhesive compositions using polymerization of, for example, epoxy, oxetane, or vinyl ether caused by an acid from a photoacid generator generated by light energy. The photocurable adhesive composition according to the present invention is preferably a UV cation epoxy adhesive, and more preferably a delayed curable UV cationic epoxy adhesive. In prior art methods, the curing mechanism is commonly heat curing, UV curing, the combination of heat and ultraviolet light, and moisture curing. It should be noted that since an amount of plastics are used in the members of inkjet recording heads, the curing temperature cannot be so high. For example, when a heat-curable adhesive composition is used, the curing time would be prolonged, and the recording element substrate and ink supply member may be deformed by thermal expansion during curing. If the recording element substrate and ink supply member deformed by thermal expansion are cooled to normal temperature, they will be shrunk, and thus deforming under stress may occur through the adhesive composition.

The photocurable adhesive composition preferably contains an alicyclic epoxy resin which exhibits high activity mainly for epoxy resins and cations. The adhesive composition preferably contains a photocationic polymerization initiator, particularly an onium salt as active species. Further, for the purpose of controlling adhesion properties, flowability, and reactivity, the adhesive composition may contain, as appropriate, a filler such as silica or carbon, a silane coupling agent, or a reactive diluent. The viscosity of the adhesive composition may be appropriately chosen according to the takt, the size of the region to be coated on the precoated structure, and the coating volume.

(Light source) The light source used in the present invention is not particularly limited as long as it is at least partially covered by a transparent member, and emits light which accelerates the curing reaction of the photocurable adhesive composition. However, as described above, the photocurable adhesive composition may be an acrylic resin composition using radical polymerization, or an epoxy resin composition using ionic polymerization, so that the light source preferably emits ultraviolet light.

For example, light guided from a low-pressure mercury lamp (185 to 254 nm), a high-pressure mercury UV lamp (365 nm), or a metal halide UV lamp (200 to 400 nm) via fibers may be used as the light source. Alternatively, an excimer lamp or an ultrahigh-pressure UV lamp may be used, and the lamp can be chosen according to the wavelength at which the photocurable adhesive composition starts to react. Alternatively, a UV-LED with low heat output in the light-emitting unit may be used.

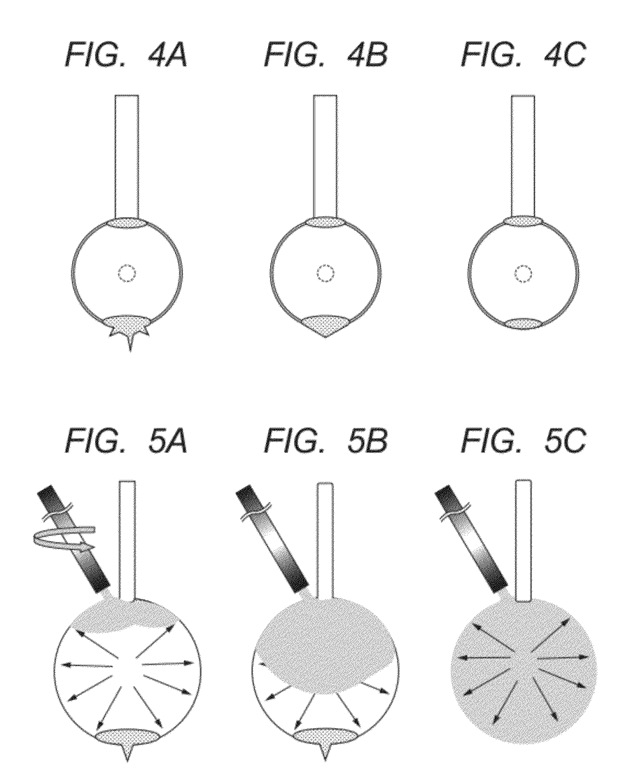

At least one of top and bottom of the light source is preferably provided with a mask, thereby preventing curing of the photocurable adhesive composition in the needle, and protecting the coated photocurable adhesive composition from excessive irradiation with ultraviolet light. The shape of the mask is not particularly limited, and may be chosen as appropriate according to the intended coating accuracy, the area and shape of the region to be coated. For example, the shape of the mask provided at the bottom of the light source may be the shape shown in FIG. 4A when the composition is thinly distributed in a large area, the shape shown in FIG. 4B when the composition is applied in a narrow area, or the shape shown in FIG. 4C when the composition is applied in a large area. Further, the wettability of the mask surface may be changed thereby controlling the dropping position.

(Transparent member) The light source used in the present invention is at least partially covered by a transparent member for drawing the photocurable adhesive composition. The photocurable adhesive composition collided with the light source forms a film on the surface of the drawing transparent member, and thus the thin film is uniformly irradiated with light. As a result of this, the occurrence of uncured areas caused by irregular irradiation with light, and the occurrence of coloration and carbonization caused by excessive irradiation are prevented.

The shape of the transparent member may be, for example, spherical or hemispherical. However, the shape is not particularly limited as long as it spreads the photocurable adhesive composition into a uniform thin film and allows uniform irradiation with light according to the shape of the region to be coated and the coating weight. The shape of the transparent member may be conical or plate. The transparent member may be made of, for example, glass or a resin which does not absorb light.

In order to prevent adhesion and deposition of the photocurable adhesive composition during a long-term operation, it is preferred that a transparent resin made of a water and oil repellent substance be applied to at least a portion of the surface of the transparent member, thereby forming a liquid repellent layer. As a result of this, wettability of the photocurable adhesive composition and the transparent member is varied, so that the composition is dropped onto the precoated structure in the region to be coated with good position accuracy. Specifically, the liquid repellent layer may be formed by thinly applying a water and liquid repellent transparent resin, whose solubility parameter is markedly different from that of the photocurable adhesive composition, to the surface of the transparent member. The material of the liquid repellent layer may be, for example, a perfluoro resin or a perfluorosilicone resin.

The thickness of the thin film formed on the surface of the transparent member varies with the supply pressure of the dispenser which supplies the photocurable adhesive composition, the flow rate of the photocurable adhesive composition, and the angle of collision between the photocurable adhesive composition and the light source. The film thickness also varies with the difference in the surface tension of the light source and the photocurable adhesive composition. The formation of a thin film of the photocurable adhesive composition can be accelerated by centrifugal force generated by rotating the transparent member as the outer part of the light source.

The shape and size of the transparent member may be chosen in consideration of, for example, the size of the region to be coated, coating speed, and the viscosity of the photocurable adhesive composition. For example, a UV curable adhesive composition having a viscosity of 4 Pa·s is applied at a rate of 3 mg/sec using a transparent member with a sphere diameter of 2 mm, formed into a thin film with a thickness of 40 μm, and fluidized.

(Structure) Examples of the structure to which the photocurable adhesive composition is applied and cured thereon include mounted substrates for electronic devices, home building materials, and microdevice bases. When the photocurable adhesive composition is used for electronic devices, the composition is applied to and cured on electrical wiring parts, thereby protecting the electrical wiring parts from moisture, solvent, acids, ink, light, and the like. The material of the structure is not particularly limited, as long as it makes intimate contact with the photocurable adhesive composition.

In particular, the structure is preferably an inkjet recording head including a recording element substrate, an electrical wiring tape connected to the recording element substrate via electrical wiring, and an ink supply member for supplying ink to the recording element substrate. In the method according to the present invention, the photocurable adhesive composition is applied to and cured on the electrical wiring connection between the recording element substrate and the electrical wiring tape of the inkjet recording head, and the gap formed by the recording element substrate, electrical wiring, electrical wiring tape, and ink supply member. According to the method of the present invention, the occurrence of uncured areas caused by irregular irradiation with light, and the occurrence of coloration and carbonization caused by excessive irradiation are prevented, and the adhesive composition completely fills the gap and hardens therein.

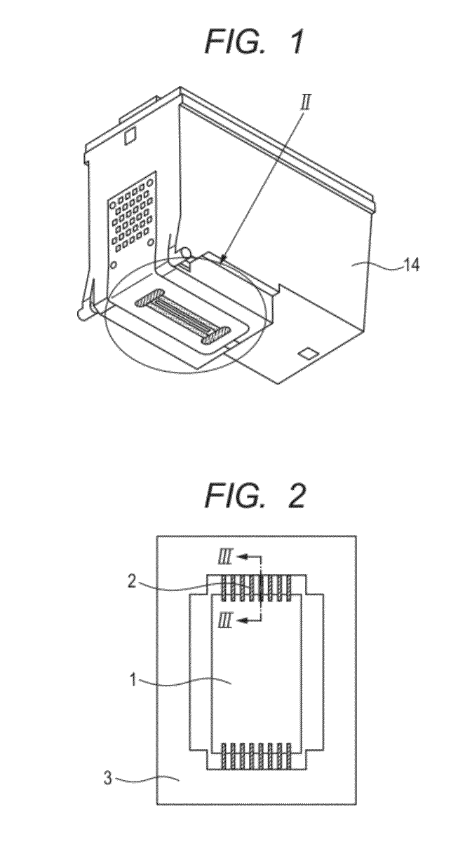

FIG. 1 is a schematic view of an example of the inkjet recording head produced by the method according to the present invention. FIG. 2 is a schematic plan view of the section II in FIG. 1. As shown in FIGS. 1 and 2, the inkjet recording head includes a recording element substrate 1, a tank case 14 as an ink supply member, and an electrical wiring tape 3. The recording element substrate 1 has an ejecting port for ejecting ink. The tank case 14 stores ink, and supplies ink to the recording element substrate 1. The electrical wiring tape 3 is connected to the recording element substrate 1 via a lead 2 as electrical wiring.

The tank case 14 may be made of any organic or inorganic material, as long as it will not cause swelling, dissolution, or elution of organic or inorganic substances upon contact with ink. The tank case 14 is preferably made of a thermoplastic resin, from the viewpoints of the cost and processability of the raw material. Examples of the material include general-purpose resins such as polypropylene and modified PPE. For the purpose of increasing the mechanical strength, a filler such as silica or alumina may be additionally used.

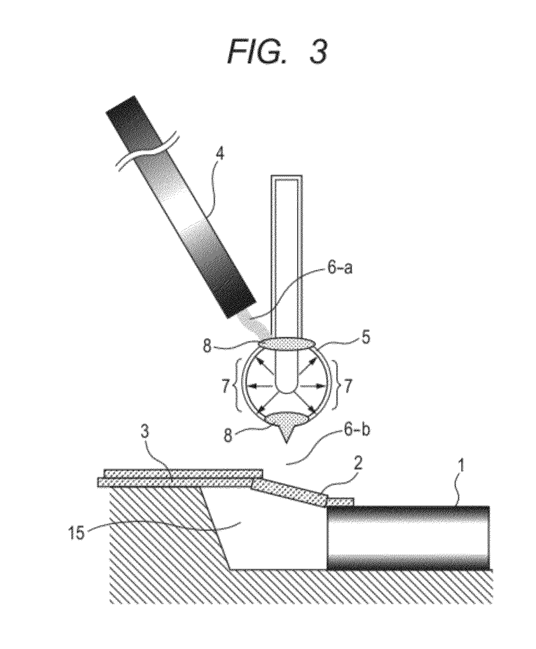

(Method for producing inkjet recording head) FIG. 3 shows an example of the method for producing an inkjet recording head according to the present invention. FIG. 3 is a cross sectional view along the line III-III in FIG. 2. A light source 5 in FIG. 3 includes masks 8 at the top and bottom. A photocurable adhesive composition 6-a ejected from a needle 4 forms a film on the surface of the transparent member, at the same time light 7 is emitted from a light source 5. The thin film of a photocurable adhesive composition 6-b is dropped onto and applied to the connection of lead 2 between the recording element substrate 1 and the electrical wiring tape 3, and a gap 15 formed by the recording element substrate 1, lead 2, electrical wiring tape 3 and ink supply member 14. At that time, the photocurable adhesive composition completely fills the gap 15 and hardens therein.

As shown in FIGS. 5A, 5B, and 5C, the photocurable adhesive composition ejected from the needle collides with the light source, slowly spreads, and forms a film. As the process proceeds in the order of FIGS. 5A, 5B, and 5C, the photocurable adhesive composition forms a film on the surface of the transparent member, while light is emitted from the light source. The angle made by the needle and the light source is not particularly limited, and these components may be arranged at any angle. In FIGS. 5A, 5B, and 5C, the needle is rotated. Alternatively, at least one of the light source and the needle may be rotated.

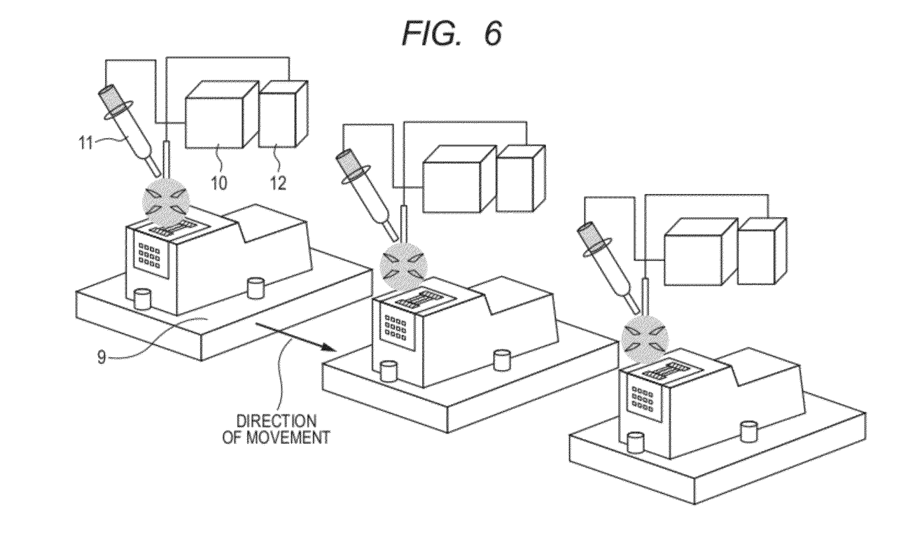

FIG. 6 shows the manner of application of the photocurable adhesive composition to an precoated inkjet recording head in the region to be coated. The photocurable adhesive composition is supplied from a dispenser 10 to a syringe 11, and the light source is connected to a photoirradiation unit 12. An precoated inkjet recording head is placed below the light source. In FIG. 6, the precoated inkjet recording head is moved, and the photocurable adhesive composition is applied thereto. Alternatively, the light source and syringe 11 may be moved. The dispenser 10 may be chosen from the dispensers used for applying liquid ink or adhesives. Examples of the dispenser include pressure-type dispensers and coating devices such as die coaters.

A specific example of the method for producing an inkjet recording head according to the present invention is described below.

A recording element substrate (chip) 1 and an electrical wiring tape (TAB tape) 3 are mounted as follows: a gold plating bump is formed on an electrode pad on the chip 1 by film formation, photolithography, or plating, and then the inner lead of the TAB is connected by heat and a load. At that time, lead forming is performed thereby preventing edge contact between the chip 1 and inner lead. The lead forming is achieved by bonding the chip 1 and TAB at different levels by Inner Lead Bonding (ILB) using a gang bonder, and then deforming the inner lead. In normal cases, ILB is performed so that the ejecting surface of the chip 1 and the polyimide surface of the TAB are oriented to the same direction. The chip 1 is bonded such that no leak occurs at the ink supplying port of the tank case 14 as a supporting member. The TAB tape 3 is bonded to the tank case 14 in the same manner as the chip 1 at the cover film side for protecting the copper foil surface, thereby preventing short or corrosion on the copper foil surface of the TAB tape 3 caused by effusion of ink attached to the ejecting surface.

Thereafter, the gap between the circumference of the chip 1 and the device hole is sealed with a photocurable adhesive composition. Further, the electrode section is coated and sealed with an epoxy resin or other photocurable adhesive composition having high sealability and ion blocking capability, thereby preventing corrosion of electrical connections of ILB caused by adhesion of fine ink droplets. According to the method of the present invention, the gap between the periphery of the chip 1 and the device hole is sealed, and the gap formed by the electrode section, TAB tape 3, and opening of the device hole, and the top of the electrode section are sealed to be covered.

A photocurable adhesive composition is supplied from a pressure-type dispenser to a syringe, and the composition is collided with a light source provided immediately below the needle of the syringe. As a result of this, the photocurable adhesive composition is formed into a thin film on the surface of the transparent member, and dropped onto the region to be coated, or the electrical wiring connection on the precoated inkjet recording head placed below the light source. The composition is fluidized and passes through the gap in the lead 2 at the electrical wiring connection, and thus completely filling the device hole section. Accordingly, in the process of production of an inkjet recording head, the method according to the present invention is suitable for the protection and sealing of the connection between an electrical wiring tape and a recording element substrate, and also protection and sealing of the footprint of the ink supply member including these components.

The method for producing a structure according to the present invention will not be limited to the above-described method for producing an inkjet recording head, and may be applied to the production of biochip and the production of liquid ejecting heads for electric circuit printing. Examples of the liquid ejecting head include inkjet recording heads and heads for producing color filters.

### EXAMPLES

In the present example, the inkjet recording head shown in FIG. 1 was produced. FIG. 2 is a schematic view of the section II in FIG. 1. As shown in FIG. 2, the inkjet recording head includes a recording element substrate 1, a lead 2, an electrical wiring tape 3, and a tank case 14.

Firstly, the recording element substrate 1 was affixed to the device hole of the tank case 14, and then the electrical wiring tape 3 is connected to the pad of the recording element substrate 1 via the lead 2, as shown in FIG. 2. Hereinafter, the object is referred to as mount assembly.

Subsequently, as shown in FIG. 6, a UV cationic epoxy adhesive (viscosity 3000 mPa·s) was supplied from a dispenser 10 to a syringe 11, and the mount assembly was placed at the application starting position. A spherical ultraviolet light source connected to an ultraviolet irradiation unit 12 was placed immediately below the needle. The mask shown in FIG. 4B was provided at the top and bottom of the light source.

The syringe 11 and the light source were moved concurrently, and the adhesive composition was applied while being squeezed by the mask. The adhesive was applied and irradiated with ultraviolet light under conditions that the UV irradiation dose was 600 mJ/cm², the ejection rate of the adhesive was 3 mg/sec, and the recording element substrate 1 was scanned 6 mm in the short axis direction. The adhesive was formed into a thin film on the surface of the transparent member of the light source, and the thickness of the thin film was several tens of nanometers. The cross section of the assembled inkjet recording head was observed and touched by fingers. As a result of this, it was confirmed that the adhesive was hard and reached the bottom of the device hole. In the present example, an inkjet recording head for black ink was produced, but the present invention will not be limited to this example, and may be used for the production of inkjet recording heads for color inks.

The present invention provides a method for producing a structure which can prevent the occurrence of uncured areas caused by irregular irradiation with light, and the occurrence of coloration and carbonization caused by excessive irradiation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-272469, filed Dec. 7, 2010, which is hereby incorporated by reference herein in its entirety.

What is claimed is:

1. A method for producing a structure, comprising:
colliding a photocurable adhesive composition with a light source, at least a portion of which light source being covered with a transparent member, thereby forming a film of the photocurable adhesive composition on the surface of the transparent member;
irradiating the film of the photocurable adhesive composition with light on the surface of the transparent member; and
dropping the photocurable adhesive composition irradiated with light on the structure in the region to be coated, thereby applying the photocurable adhesive composition to the region to be coated.

2. The method for producing a structure according to claim 1, wherein at least one of top and bottom of the light source is provided with a mask.

3. The method for producing a structure according to claim 1, wherein the light is ultraviolet light, and the composition is a UV cationic epoxy adhesive.

4. The method for producing a structure according to claim 1, wherein at least a portion of the surface of the transparent member is provided with a liquid repellent layer.

5. A method for producing an inkjet recording head comprising a recording element substrate, an electrical wiring tape connected to the recording element substrate via electrical wiring, and an ink supply member for supplying ink to the recording element substrate, the method comprising:
colliding a photocurable adhesive composition with a light source, at least a portion of which light source being covered with a transparent member, thereby forming a film of the photocurable adhesive composition on the surface of the transparent member;
irradiating the film of the photocurable adhesive composition with light on the surface of the transparent member; and
dropping the photocurable adhesive composition irradiated with light on the inkjet recording head in the region to be coated, thereby applying the photocurable adhesive composition to the region to be coated,
wherein the region to be coated comprises the electrical wiring connection between the recording element substrate and the electrical wiring tape, and a gap formed by the recording element substrate, electrical wiring, electrical wiring tape, and ink supply member.

6. The method for producing an inkjet recording head according to claim 5, wherein at least one of top and bottom of the light source is provided with a mask.

7. The method for producing an inkjet recording head according to claim 5, wherein the light is ultraviolet light, and the composition is a UV cation epoxy adhesive.

8. The method for producing an inkjet recording head according to claim 5, wherein at least a portion of the surface of the transparent member is provided with a liquid repellent layer.
